(19) United States
(12) Patent Application Publication
(10) Pub. No.: US 2002/0072991 A1
(43) Pub. Date: Jun. 13, 2002

(54) System and method for computerized ordering of vaccines

(76) Inventor: John Kane, Maple Glen, PA (US)

Correspondence Address: Woodcock Washburn Kurtz, Mackiewicz & Norris LLP, One Liberty Place - 46th Floor, Philadelphia, PA, 19103, US

(21) Appl. No.: 09/951,868

(22) Filed: Sep. 13, 2001

Related U.S. Application Data
(60) Provisional application No. 60/232,352, filed on Sep. 14, 2000.

(51) Int. Cl. G06F 17/60; H04L 9/00

(52) U.S. Cl. 705/26; 713/201

(57) ABSTRACT

A vaccine product is ordered via a computer communications network such as for example the Internet. An indication of a purchaser is received via the communications network. The purchaser indication may include a purchaser identification, account information, shipping information, and a purchase identification. An indication of a vaccine product and an indication of a quantity to be ordered is received via the communications network. The order is processed based on the purchaser, the vaccine product, and the quantity.

### CROSS REFERENCE TO RELATED APPLICATIONS

This application claims the benefit of U.S. Provisional Application No. 60/232,352 entitled “Ordering Vaccines by the Internet”, filed Sep. 14, 2000, and hereby incorporated by reference in its entirety.

Copyright Notice

A portion of the disclosure of this patent document contains material that is subject to copyright protection. The copyright owner has no objection to the facsimile reproduction by anyone of the patent document or the patent disclosure as it appears in the United States Patent & Trademark Office patent file or records, but otherwise reserves all copyright rights whatsoever.

### FIELD OF THE INVENTION

The invention relates generally to computerized ordering of vaccines and more particularly to computerized ordering of vaccines via a communications network.

### BACKGROUND OF THE INVENTION

Typically, vaccine products are ordered from a vaccine supplier over a telephone. Such ordering can be time consuming and cumbersome. For example, a purchaser may telephone the vaccine supplier, verbally request pricing information, verbally place an order, receive verbal confirmation, receive a paper confirmation in the mail, review the paper confirmation, and may telephone the vaccine supplier again if the paper confirmation is incorrect. This method may take an unacceptably long time and result in an unacceptable amount of errors.

Such an ordering system also offers limited support services and information to a purchaser. For example, the person receiving the order may not have access to information such as vaccine information, disease information, educational information, and the like. Without such information, a user may not be able to make the best purchasing decision. Further, without support services and vaccine product information, purchasers often perceive little differentiation among vaccine manufacturers' offerings.

In addition, although today's vaccine market is focused almost exclusively upon pediatrics, many new vaccines are developed for adults and adolescents. However, information on such new vaccines often does not reach the appropriate people to effectuate the vaccination of such adults and adolescents.

Therefore, a need exists for a system and method for ordering vaccine products and for providing information and support services relevant to such vaccine products.

### SUMMARY OF THE INVENTION

The invention is directed to a computerized system and method for ordering vaccine products and for providing information and support services relevant to such vaccine products via a computer communications network.

According to one aspect of the invention, a vaccine product is ordered via a computer communications network, such as for example, the Internet. An indication of a purchaser is received via the communications network. The purchaser indication may include a purchaser identification, account information, shipping information, and a purchase identification. If a purchaser identification is associated with only one shipping address and only one account, then the order can be processed based on the purchaser identification alone. However, if one purchaser is associated with more than one account or more than one shipping address, then a selection is received of an account or a shipping address. An indication of a vaccine product and an indication of a quantity to be ordered is received via the communications network. The order is processed based on the purchaser, the vaccine product, and the quantity.

According to another aspect of the invention, a password is required before access to an order processing system is granted. A prompt for a password is sent via the communications network. A password is received via the communications network, the received password is compared to a predefined password. Access is granted only if the received password is identical to the predefined password.

According to a further aspect if the invention, a list of vaccine products available for ordering is sent via the communications network for displaying to a purchaser, wherein the purchaser can select from the list a vaccine products and a quantity thereof. The list of vaccine products may include a price for each vaccine product.

According to yet another aspect of the invention, the purchaser can review an order and either accept or reject the order. An indication of the vaccine product, the quantity, and the determined price is sent via the communications network for confirmation of the order. If confirmation of the order is received the order is processed. Once the order is processed, a confirmation may be sent to the purchaser. The confirmation may be in the form of a web page or an e-mail.

According to a further aspect of the invention, the order may be processed with a credit card number or with extended credit terms.

According to another aspect of the invention, order history may be retrieved via the communications network. A search criterion for a vaccine product order is received via a communications network. A data store is searched for a vaccine product order based on the search criterion. At least one vaccine product order meeting the search criterion is sent via the communications network. The search criterion may be a purchase order number or a date range.

According to another aspect of the invention, vaccine product information is provided via a computer communications network. An indication of a vaccine product is received via the communications network and selected information is sent via the communications network. The information may include product information, prescribing information, support information, a hyper text transport protocol link to other information, an article, and storage and handling information.

According to a further aspect of the invention, purchaser relevant vaccine product information is provided via a computer communications network. An indication of a purchaser is received via the communications network and an area of interest is determined corresponding to the purchaser. Vaccine product information is then sent via the communication network based on the determined area of interest.

According to another aspect of the invention, purchaser service is increased by providing vaccine product pricing information via a computer communications network, providing vaccine product support information via the communications network, receiving vaccine product order information via the communications network, and processing a vaccine product order based on the order information.

Other features of the invention will become evident hereinafter.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the several views of the drawings, and wherein:

FIG. 1 is a block diagram of a computing device and communications network with which the invention may be employed and an order processing system in accordance with an embodiment of the invention;

FIG. 2 is a block diagram of a vaccine order processing system, including an order processing application and a data store, in accordance with an embodiment of the invention;

FIG. 3 is a screen shot of an illustrative web page showing a main menu for computerized ordering of a vaccine and providing vaccine product information, in accordance with an embodiment of the invention;

FIG. 4 is a screen shot of an illustrative web page for receiving a selection of a disease, in accordance with an embodiment of the invention;

FIG. 5 is a screen shot of an illustrative web page displaying disease information, in accordance with an embodiment of the invention;

FIG. 6 is a flow chart of a method for providing vaccine product information via a communications network and illustrating the operation of the system of FIG. 2, in accordance with an embodiment of the invention;

FIG. 7 is a screen shot of an illustrative web page for receiving a selection of a vaccine product, in accordance with an embodiment of the invention;

FIG. 8 is a screen shot of an illustrative web page displaying vaccine product information, in accordance with an embodiment of the invention;

FIG. 9 is a screen shot of an illustrative web page displaying vaccine prescribing information, in accordance with an embodiment of the invention;

FIG. 10 is a screen shot of an illustrative web page displaying vaccine support information, in accordance with an embodiment of the invention;

FIG. 11 is a screen shot of an illustrative web page displaying online information relevant to vaccines, in accordance with an embodiment of the invention;

FIG. 12 is a screen shot of an illustrative web page displaying articles relevant to vaccines, in accordance with an embodiment of the invention;

FIG. 13 is a screen shot of an illustrative web page displaying vaccine storage and handling information, in accordance with an embodiment of the invention;

FIG. 14 is a screen shot of an illustrative web page displaying recent vaccine information, in accordance with an embodiment of the invention;

FIG. 15 is a flow chart of a method for ordering a vaccine product via a communications network and illustrating the operation of the system of FIG. 2, in accordance with an embodiment of the invention;

FIG. 16 is a screen shot of an illustrative web page including a menu for ordering a vaccine product, in accordance with an embodiment of the invention;

FIGS. 17a through 17d are screen shots of illustrative web pages for ordering a vaccine product, in accordance with an embodiment of the invention;

FIG. 18 is a flow chart of a method for providing vaccine product order information via a communications network and illustrating the operation of the system of FIG. 2, in accordance with an embodiment of the invention; and

FIG. 19 is a screen shot of an illustrative web page for receiving a time and date range or purchase order identification for an order history, in accordance with an embodiment of the invention.

### DETAILED DESCRIPTION OF ILLUSTRATIVE EMBODIMENTS

The invention is directed to a computerized system and method for ordering vaccine products and for providing information and support services relevant to such vaccine products via a communications network.

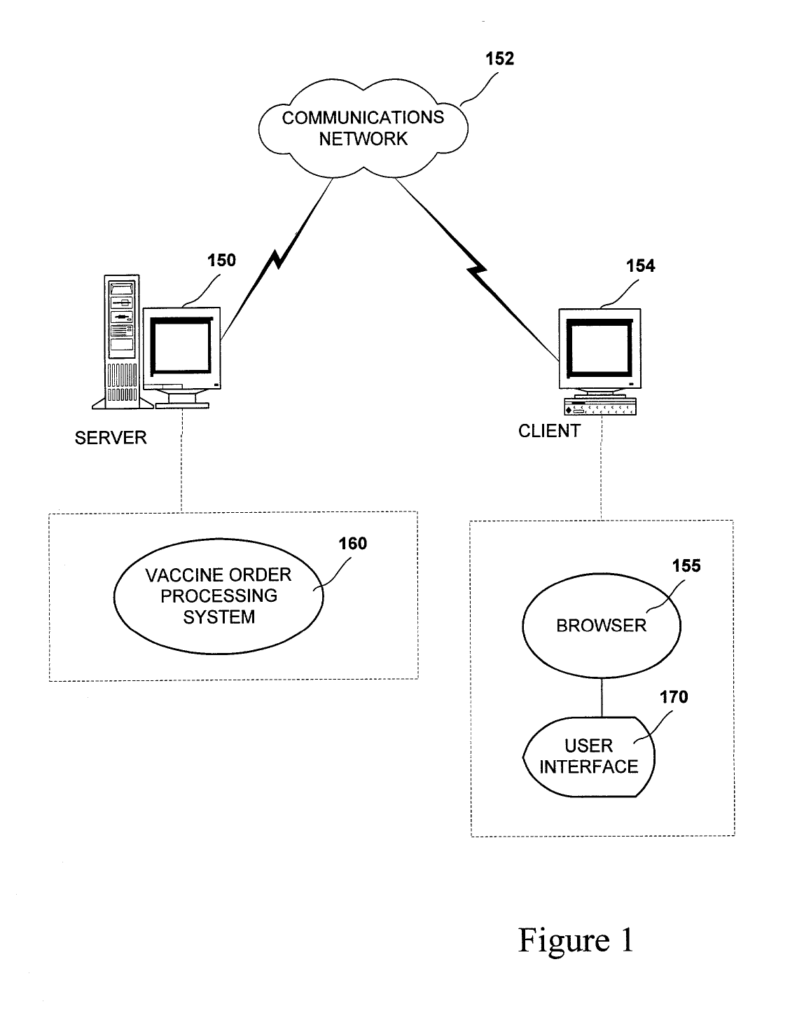

FIG. 1 illustrates a computer network environment with which the invention may be employed and a system for vaccine order processing 160, although it should be understood that the invention need not be employed in a network environment. As shown in FIG. 1, server 150 is interconnected with client computer 154 via computer communications network 152. In this environment, communications network 152 is the Internet, however, communications network 152 can also be, for example, a local area network (LAN), a wide area network (WAN), or an intranet. In a network environment in which communications network 152 is the Internet, server 150 is known as a Web server. Server 150 and client computer 154 can communicate with each other via any mutually agreeable protocol, such as the well known hyper-text transfer protocol (HTTP), for example. Although FIG. 1 shows a network environment with one server and one client, it should be understood that the network could include any number of clients and servers.

Typically, a client computer 154 interfaces with communications network 152 via a browser 155 that enables a user (not shown) at client computer 154 to access Web sites on server 150. Currently, a number of well-known browsers 155 are commercially available for personal computers and other Internet appliances. However, server 150 may also be accessed by any device capable of accessing a server 150 across a communications network 152, including a cellular phone, an Internet appliance, a personal digital assistant (PDA), a wireless hand-held device, and the like. Additionally, client computer 154 includes a user interface 170 allowing the user (i.e., a vaccine purchaser) to send and receive data to and from server 150.

To connect to server 150, the user at client computer 154 executes browser 155 and then enters an address, such as a domain name (for example, “www.merckvaccines.com”) or a Universal Resource Locator (URL) (for example, “www.merckvaccines.comlweb-server.htm”). If the URL “www.merckvaccines.com/web-server.htm” is entered, browser 155 breaks the URL into 3 parts: the protocol (“http”), the server name (“www.merckvaccines.com”), and the file name (“web-server.htm”). In either case, browser 155 communicates with a domain name server (DNS) (not shown) to translate the server name (www.merckvaccines.com) into an Internet Protocol (IP) address. Browser 155 then uses the IP address to connect client computer 154 to server 150 via communications network 152.

Server 150 can then send data, such as vaccine information, vaccine pricing, support information, and the like, that browser 155 needs to build the requested Web page at client computer 154 (e.g., by reading HTML tags and formatting the page onto the client's video display terminal). The user can then “navigate” the Web site (i.e., move from one Web page to another) by entering commands on the current Web page (e.g., by selecting so-called “hyperlinks” that are available on the current Web page). Typically, selecting a hyperlink will cause the user to “jump” to another Web page (i.e., the Web server will download to the client a Web page corresponding to the selected hyperlink). Whenever order processing system 160 receives a request from client computer 154 for a Web page, order processing system 160 determines the data that should be sent to client computer 154 to build the requested Web page and interfaces with a data store, described in more detail below, to obtain such data. As the user navigates the Web site, server 150 continues to send data for the Web pages in response to such user-entered commands.

Server 150 can also receive data such as for example, a quantity, an indication of a vaccine product, a selection of a vaccine product, and the like that order processing system 160 uses to process a vaccine product order. In this manner, a vaccine purchaser may purchase a vaccine and receive vaccine and other information, as described in more detail below.

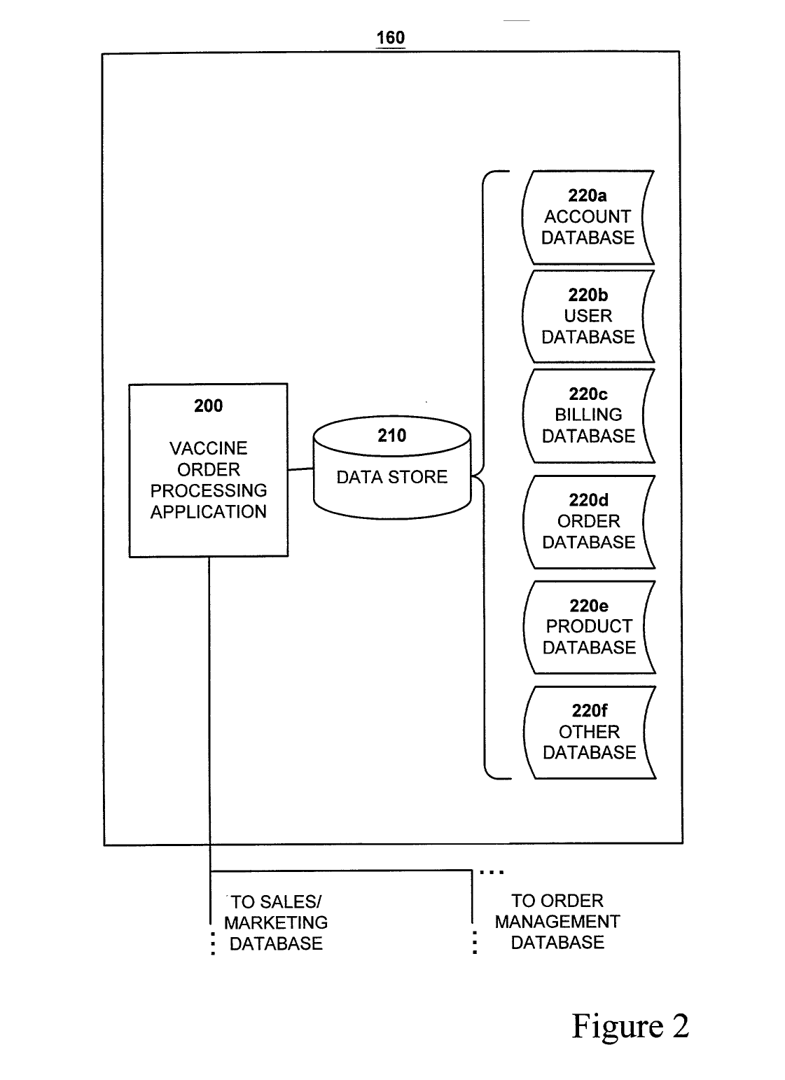

FIG. 2 is a block diagram illustrating details of order processing system 160. As shown in FIG. 2, order processing system 160 includes order processing application 200 and data store 210. Data store 210 includes account database 220a, user database 220b, billing database 220c, order database 220d, product database 220e, and other database 220f.

As may be understood, the invention works in conjunction with the several databases in the course of receiving and fulfilling the order and also in providing information and support services relevant to vaccine products. Understandably, such databases may take any particular form and have any particular organization. For example, databases 220 may be implemented using any commercially available database application and may be implemented as individual databases or as a single database. Such databases are accessed by an appropriate database server or the like.

In the present embodiment, the invention is available by way of a web site having a plurality of linked web pages. Preferably, the web pages of the web site of the invention are served by an appropriate web site server or the like, where such web site server has appropriate access to the database server or the like. As may be appreciated, the actual architecture employed for the servers and databases and the interconnections thereof may be any appropriate architecture. The details of such architecture should be apparent to the relevant public and therefore need not be described herein in any detail.

Referring back to databases 220, account database 220a includes account information such as for example, an account name, pricing information for each account, and the like. Based on pricing information, order processing application 200 may price each ordered vaccine product to give the purchaser the benefit of the best available pricing terms and display such pricing to the purchaser. Alternatively, order processing application 200 may display all pricing terms to the purchaser. Thus, order processing application 200 can calculate pricing for the order based on an account, and based on other pricing indicia (shipping location, quantity ordered, etc.).

User database 220b includes user information such as for example, a purchaser name, at least one account name, a shipping address, and the like. Based on user information and account information (i.e., corresponding to an account name of the purchaser), order processing application 200 can process an order to the appropriate purchaser using the appropriate account. Also, the purchaser may select from among multiple accounts when ordering, if in fact the purchaser has access to more than one account.

Billing database 220c includes billing information such as for example, an account name, an amount and date billed for a particular transaction, an amount and date received for a particular transaction, and the like. Based on the billing information, order processing application 200 can determine a purchaser's or an account's total amount billed, total amount received, total amount outstanding, and the like.

Order database 220d includes order information such as for example, a vaccine product ordered, a quantity ordered, a purchaser, an account, a shipment date, and the like. Based on the order information, order processing application 200 can determine the current status of an order, determine past orders for a particular purchaser or account, and the like.

Product database 220e includes product information such as for example, product information, prescribing information, support materials, web addresses of online resources relevant to vaccines, articles relevant to vaccines, and storage and handling information. Based on the product information, order processing application 200 can display information relevant to a vaccine product and a purchaser's decision regarding the purchase and use of a vaccine product.

Other database 220f includes other information such as for example, disease information and the like. Based on such information, order processing application 200 can display information relevant to a purchaser's decision regarding the purchase and use of a vaccine product.

As shown, order processing application 200 may work with and/or provide information to a sales and marketing database, an order management database, and the like. As such, order processing system 160 may be integrated with a vaccine supplier's various computing systems.

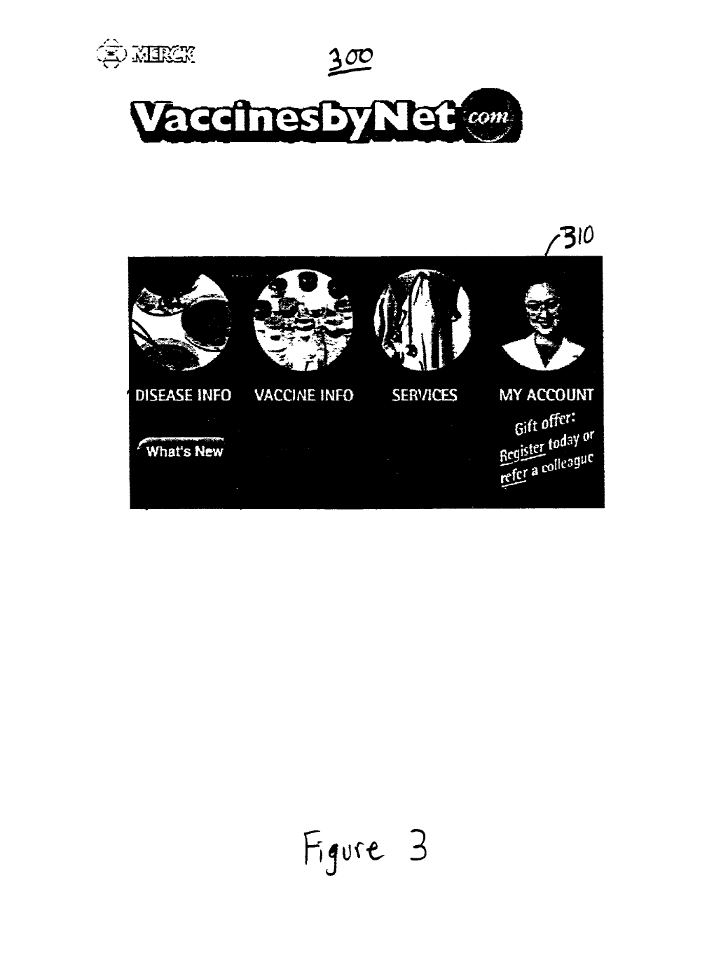

Order processing application 200 uses databases 220 to store and retrieve information to be sent via communications network 152 for use in displaying web pages. FIG. 3 is a screen shot of an illustrative web page 300 showing a main menu 310 for computerized ordering of a vaccine product and for providing information and support services relevant to such vaccine products. As shown in FIG. 3, order processing application 200 displays “Disease Info,” “Vaccine Info,” “Services,” “My Account,” and “What's New” on main menu 310. Order processing application 200 may cooperate with client computer 154 to cause client computer 154 to display web pages.

Order processing application 200 receives a selection of one of “Disease Info,” “Vaccine Info,” “Services,” and “My Account.” The selection may be received via a mouse click, a keyboard keystroke, a touch-screen touch, or the like at client computer 154. The selection is transmitted via communications network 152 to server 150. Order processing application 200 receives and processes the selection accordingly, as described in more detail below.

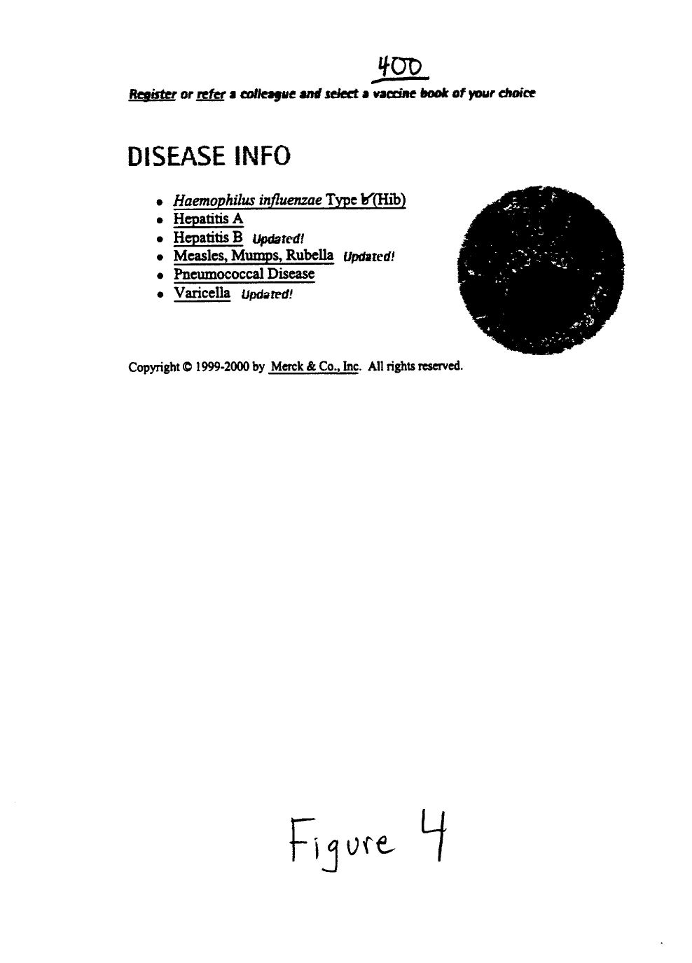

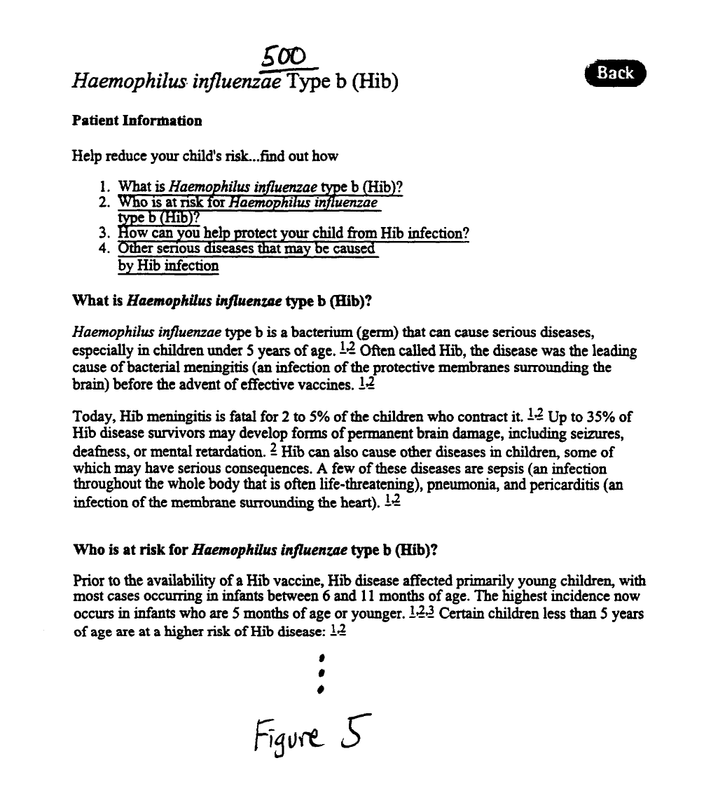

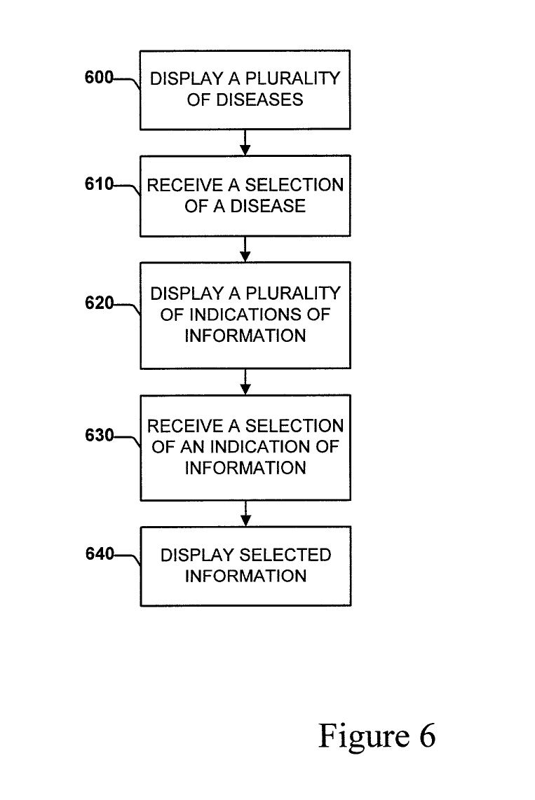

Upon receiving a selection of “Disease Info”, order processing application 200 displays web page 400, as shown in FIG. 4, by sending the appropriate data via communications network 152 to client computer 154. Web page 400 includes disease names such as “Haemophilus influenzae Type b (Hib)”, “Hepatitis A”, and the like. Order processing application 200 receives a selection of a disease name and displays disease information relevant to the selected disease. For example, if order processing application 200 receives a selection of “Haemophilus influenzae Type b (Hib)”, order processing application 200 displays web page 500, as shown in FIG. 5. Web page 500 includes information about the disease Haemophilus influenzae Type b (Hib).

Referring again to FIG. 3, upon receiving a selection of “Vaccine Info”, order processing application 200 begins executing a method for providing vaccine product information via a communications network.

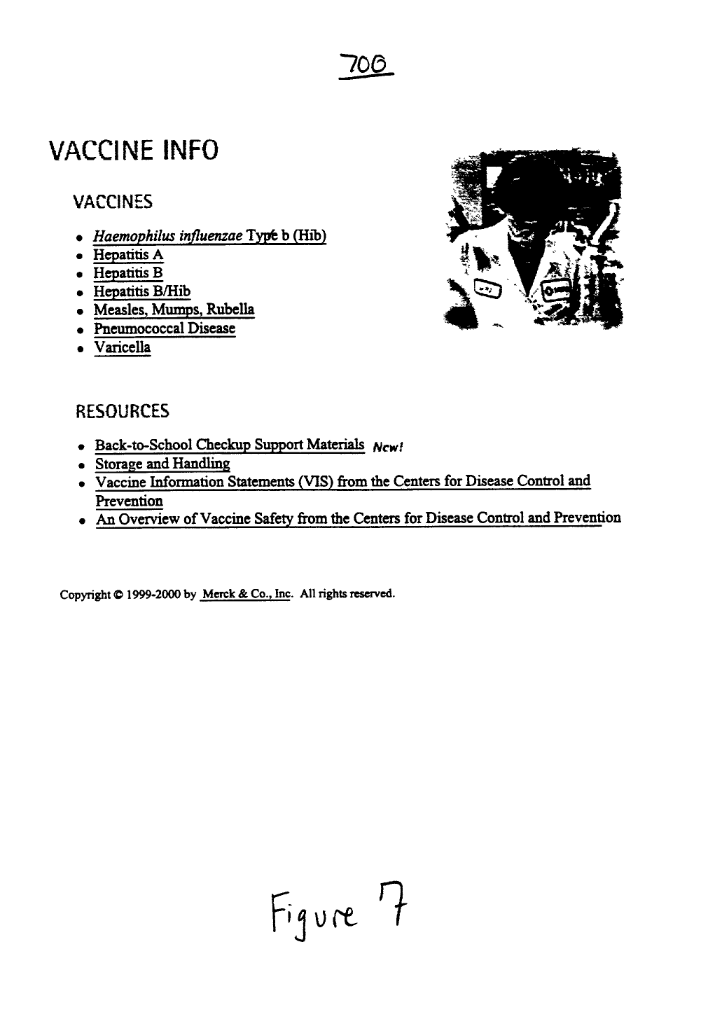

At step 600, order processing application 200 displays a plurality of diseases. In this illustration, order processing application 200 displays web page 700, as shown in FIG. 7. Web page 700 includes disease names such as “Haemophilus influenzae Type b (Hib)”, “Hepatitis A”, and the like.

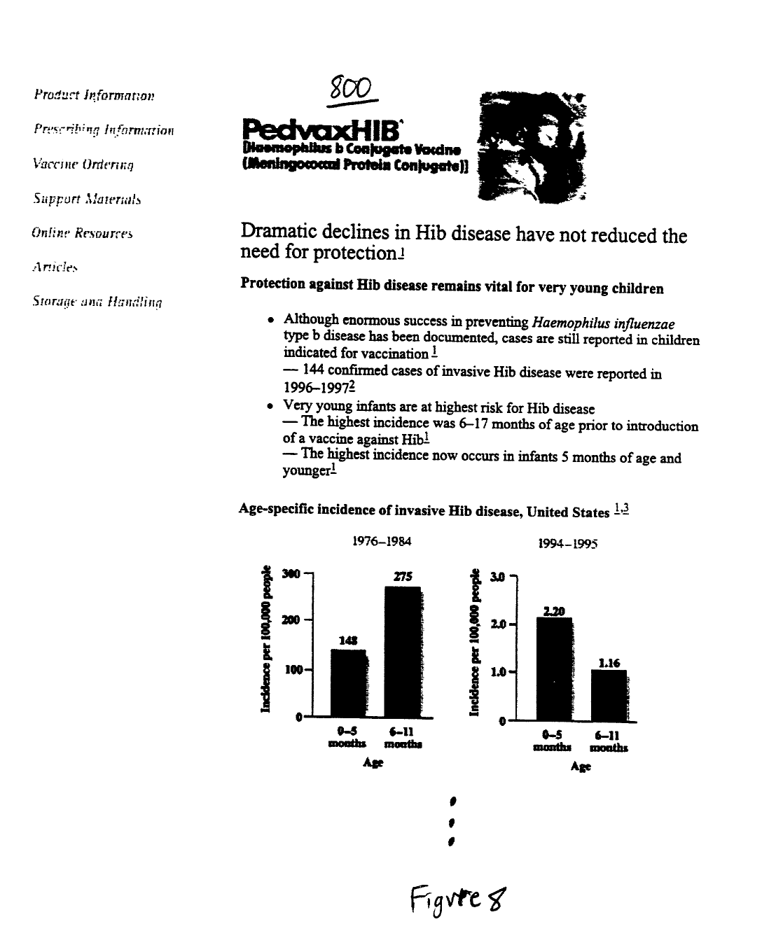

At step 610, order processing application 200 receives a selection of a disease name and displays vaccine information relevant to the selected disease. For example, if order processing application 200 receives a selection of “Haemophilus influenzae Type b (Hib)”, order processing application 200 displays web page 800, as shown in FIG. 8. Web page 800 displays information describing a particular vaccine for the disease Haemophilus influenzae Type b (Hib), in this case, a PedvaxHIB vaccine. Order processing application 200 may display a plurality of vaccines available from a plurality of vaccine suppliers. If only one vaccine product is displayed, then such vaccine is the selected vaccine. If several vaccine products are displayed, then one of the vaccine products may be selected by the purchaser, thereby becoming the selected vaccine product.

At step 620, order processing application 200 displays a plurality of information indications. In this illustration, web page 800 displays “Prescribing Information,” “Vaccine Ordering,” “Support Materials,” “Online Resources,” “Articles,” and “Storage and Handling,” as seen in FIG. 8 and which can be selected by a purchaser.

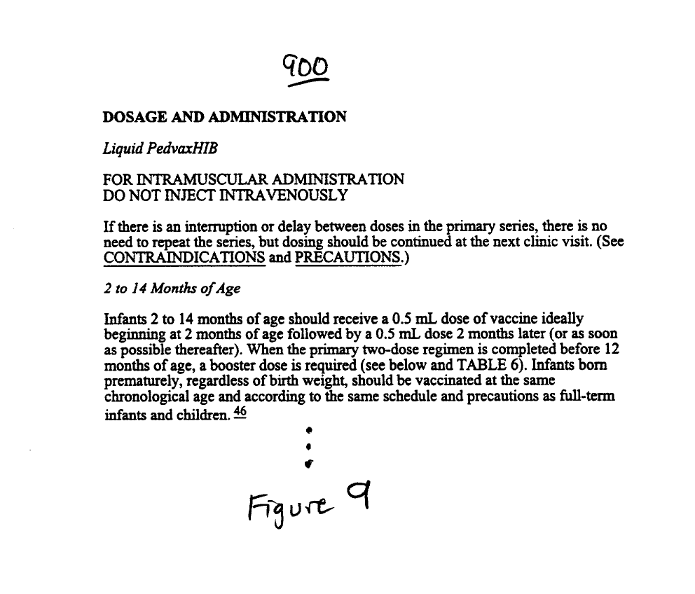

At step 630, order processing application 200 receives a selection of an information indication. At step 640, order processing application displays the selected information. For example, if order processing application 200 receives a selection of “Prescribing Information”, order processing application 200 displays web page 900, as shown in FIG. 9. Web page 900 includes information on dosage and administration of the selected vaccine product.

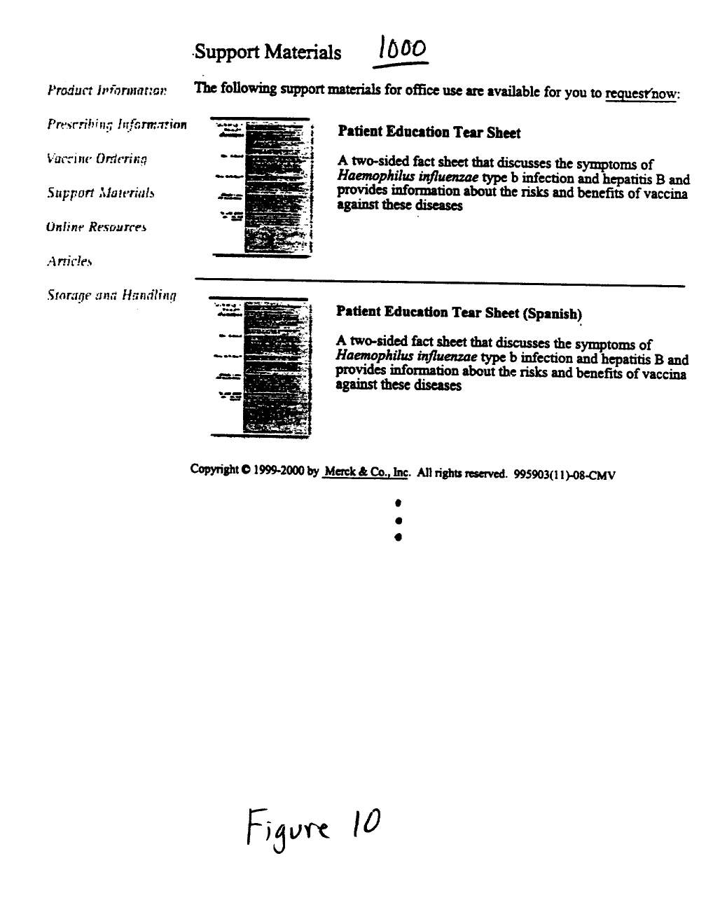

Referring again to FIG. 8, if order processing application 200 receives a selection of “Support Materials”, order processing application 200 displays web page 1000, as shown in FIG. 10. Web page 1000 includes information on available support materials relevant to the selected vaccine product. Support materials may include patient education tear sheets and the like.

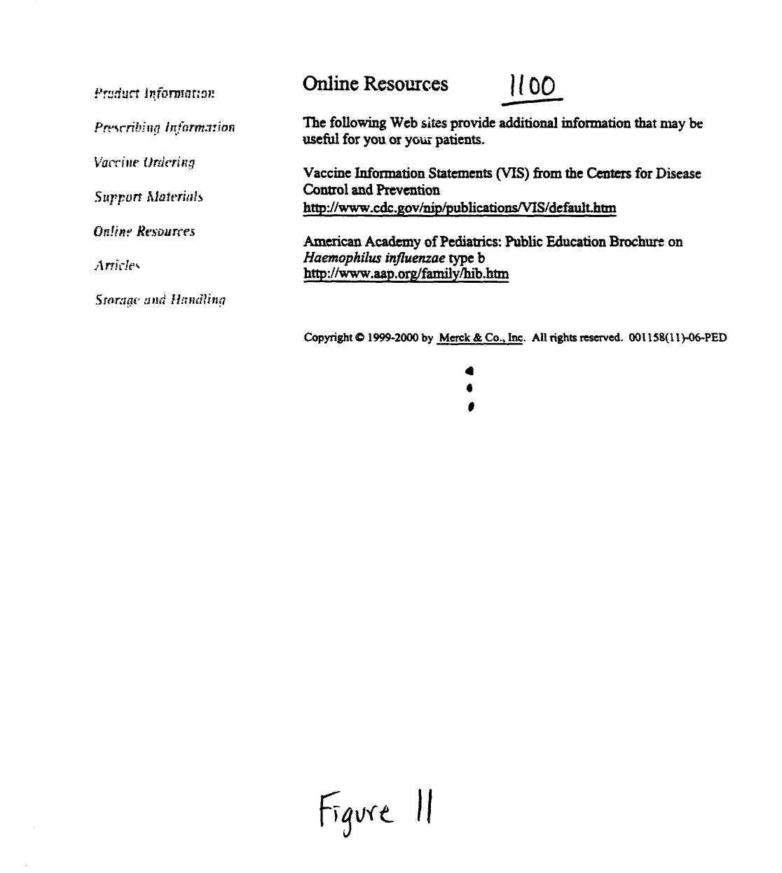

Referring once again to FIG. 8, if order processing application 200 receives a selection of “Online Resources”, order processing application 200 displays web page 1100, as shown in FIG. 11. Web page 1100 includes hyperlinks to other relevant resources on the Internet, whereby a purchaser may select a hyperlink and view other sources of information relevant to the selected vaccine.

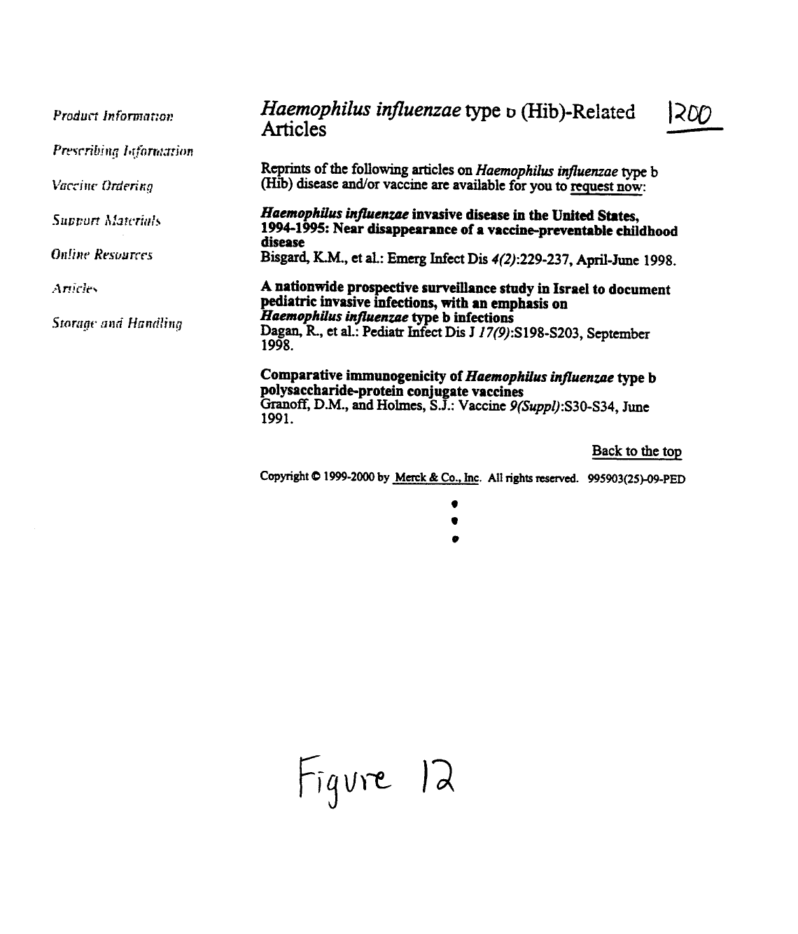

Referring yet again to FIG. 8, if order processing application 200 receives a selection of “Articles”, order processing application 200 displays web page 1200, as shown in FIG. 12. Web page 1200 displays names of articles relevant to the selected vaccine. As such, a purchaser may obtain an article relevant to vaccines.

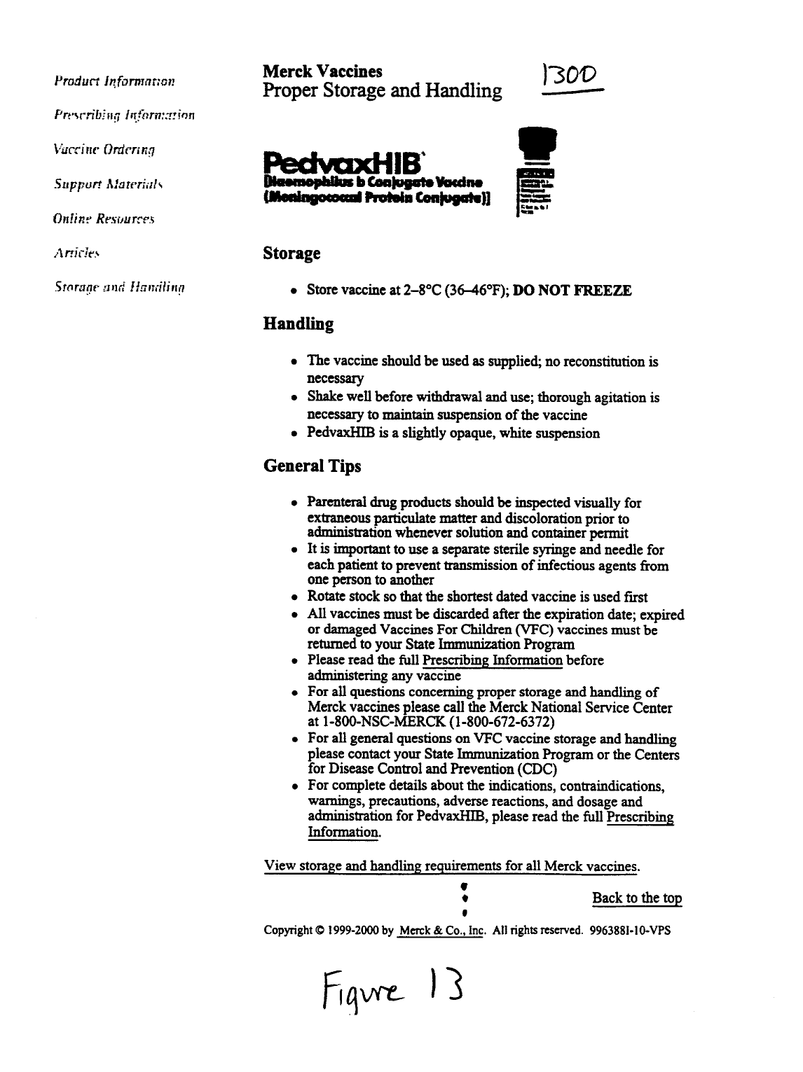

Referring again to FIG. 8, if order processing application 200 receives a selection of “Storage and Handling”, order processing application 200 displays web page 1300, as shown in FIG. 13. Web page 1300 displays storage and handling information relevant to the selected vaccine. As such, a purchaser may quickly access storage and handling information of a particular vaccine product.

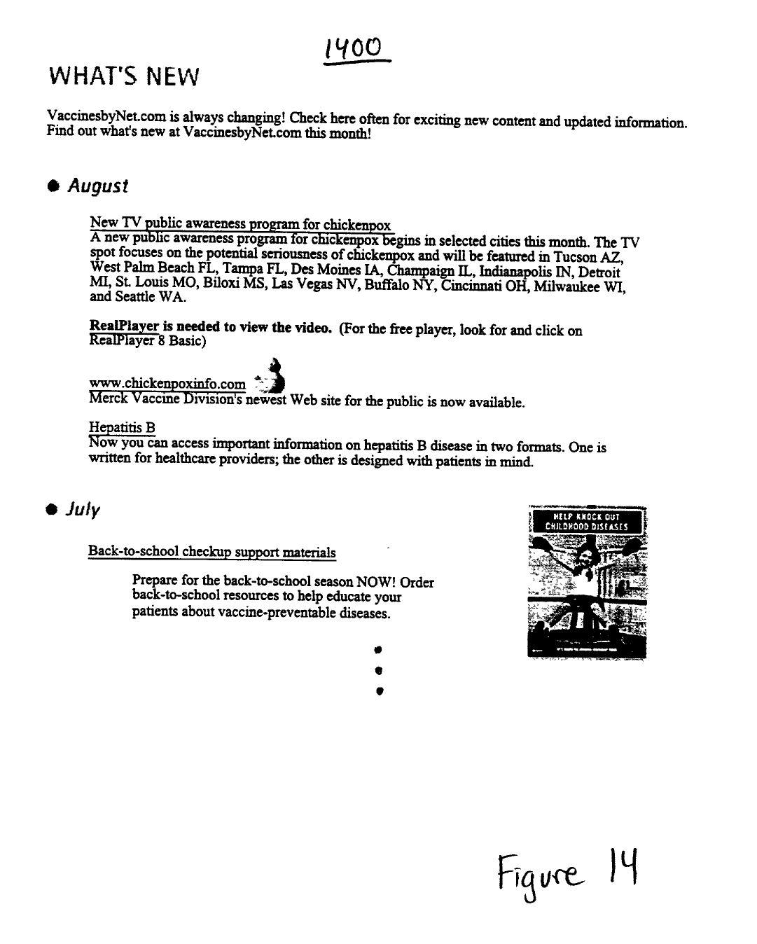

Referring back to FIG. 3, upon receiving a selection of “What's New”, order processing application 200 displays web page 1400, as shown in FIG. 14. Web page 1400 includes recent information relevant to vaccines. In this manner, a vaccine purchaser may remain up-to-date with recent information regarding vaccines.

In one embodiment, the recent information is personally relevant recent information. In this embodiment, user database 220b includes personally relevant information of the purchaser. For example, if the purchaser is a doctor that specializes in measles, user database 220b includes a data field containing an indication that the doctor specializes in measles. Order processing application 200 reads the data field and determines information relevant to the indicated specialty. Order processing application 200 then sends such relevant information via communications network 152. As such, the doctor can receive up-to-date information regarding measles vaccines without having to receive and sift through other information that is not as relevant to the doctor. In another embodiment, personally relevant information is received via the Internet or from another database, rather than from user database 220b.

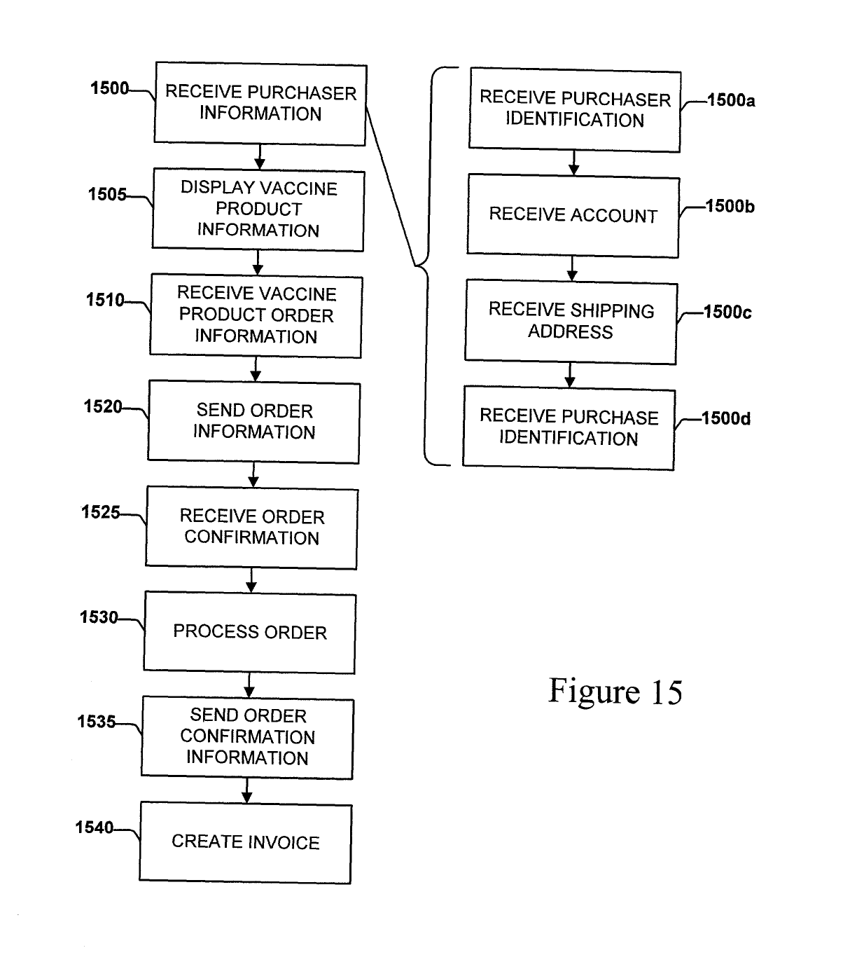

Referring again to FIG. 3, upon receiving a selection of “My Account”, (or a selection of “Vaccine Ordering” of FIG. 8) order processing application 200 performs a method for ordering vaccine product via a communications network as shown in FIG. 15.

Prior to proceeding with the method as shown in FIG. 15, order processing application 200 may request a password from the purchaser. For example order processing application 200 may send a prompt for a password, receive a password, and compare the received password to a predefined password. The predefined password may be stored in user database 220b corresponding to a user identification for the purchaser. It is anticipated that the invention will be employed by health-care professionals who use vaccines, and primarily by public and private pediatric physician clinic purchasers, specifically physicians, nurses and office managers, therefore, such personnel may be granted passwords to access vaccine product ordering. Other users may include medical and purchasing decision-makers within the Center for Disease Control (CDC), state and local immunization programs, hospitals, GPOs, Managed Care Organizations (MCOs) and other institutional purchasers who influence health care professionals' use and purchase decisions such as through reimbursement and the like. Again, such personnel may be granted a password to access vaccine product ordering. Other persons may be granted access to vaccine product information but not be granted access to vaccine product ordering. Still other persons may be granted access to neither.

If the received password is not identical to the predefined password, then the purchaser is denied access to particular web pages, including web pages directed to ordering a vaccine product and optionally, web pages directed to providing vaccine product information and support services.

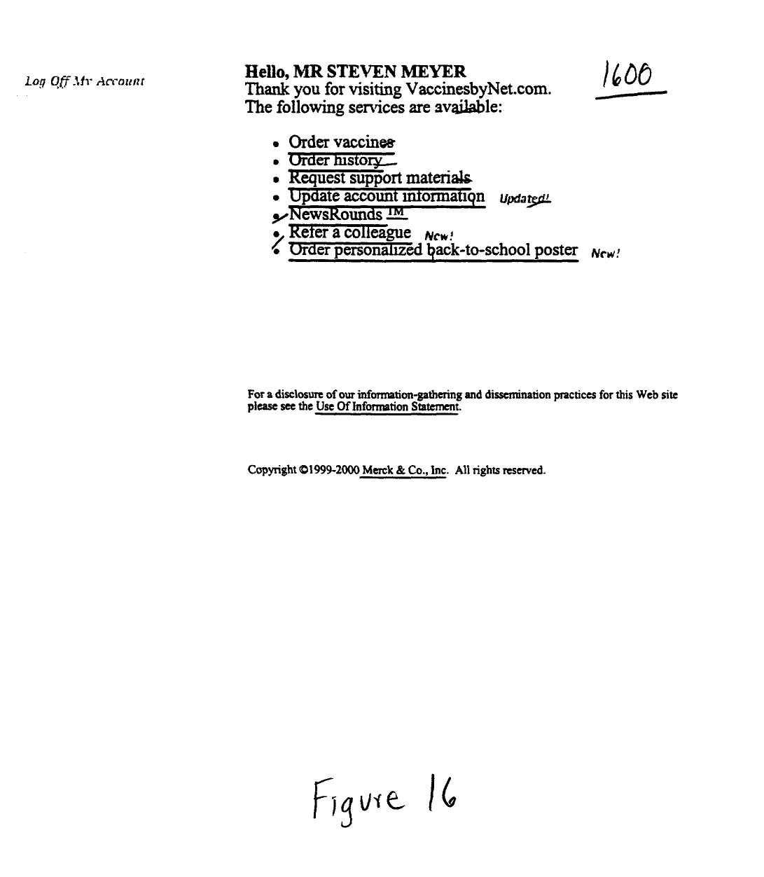

If, however, the received password is identical to the predefined password, order processing application 200 displays web page 1600, as shown in FIG. 16. Web page 1600 displays “Order Vaccines,” “Order History,” “Request Support Materials,” and “Update Account Information” and begins execution of the method of FIG. 15.

At step 1500, order processing application 200 receives purchaser information. Purchaser information may take several forms.

Purchaser information may include a purchaser identification as shown at step 1500a. Purchaser identification may include a purchaser name, a purchaser identification number, a selection of a purchaser name, and a selection of a purchaser identification. If a purchaser identification is associated with only one shipping address and only one account, then order processing application 200 can process the order based on the purchaser identification alone. However, if one purchaser is associated with more than one account or more than one shipping address, then order processing application 200 requests that an account and a shipping address be selected by the user.

For example, at step 1500b, order processing application 200 receives account information, such as an account name, an account identification number, a selection of an account name, and a selection of an account identification. In one embodiment, user database 220b identifies all accounts that the purchaser may order a vaccine product under. Such accounts may include contracts directly with the vaccine supplier, contracts between the supplier and one or more health organizations which the purchaser may claim the benefit of, and the like. Further, each contract may have different pricing features for vaccine products. The account information may be stored in account database 220a.

At step 1500c, order processing application 200 receives shipping information such as for example, a shipping address. The ordered vaccines may be shipped to any of several shipping locations available for the purchaser. If the purchaser has multiple shipping locations, the purchaser selects from among the multiple shipping locations when ordering. Such shipping location(s) may be stored in user database 220b.

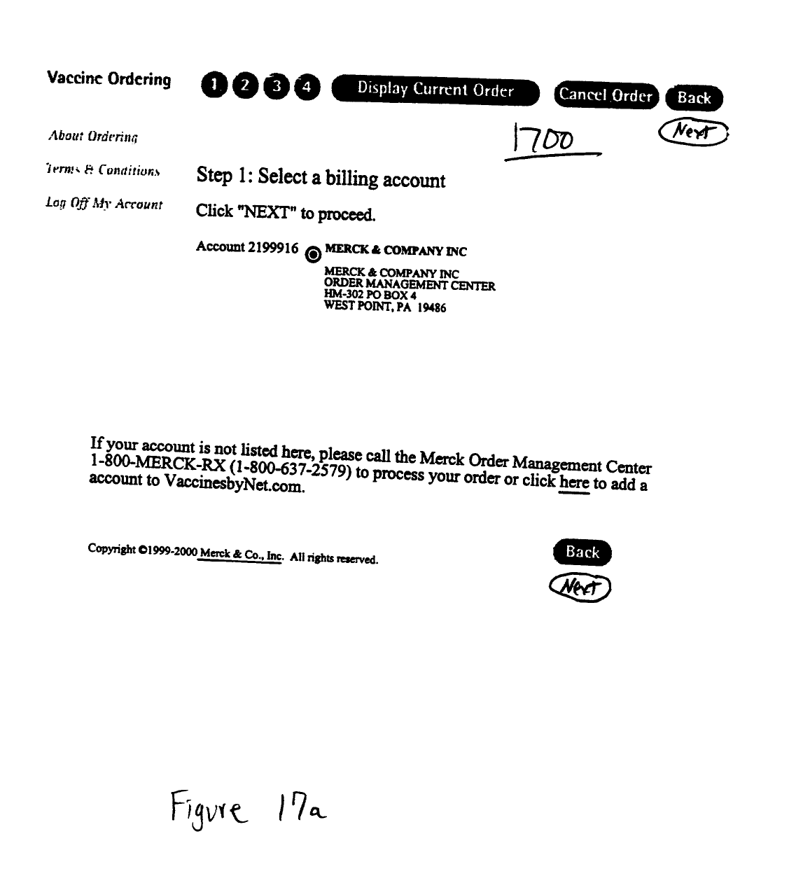

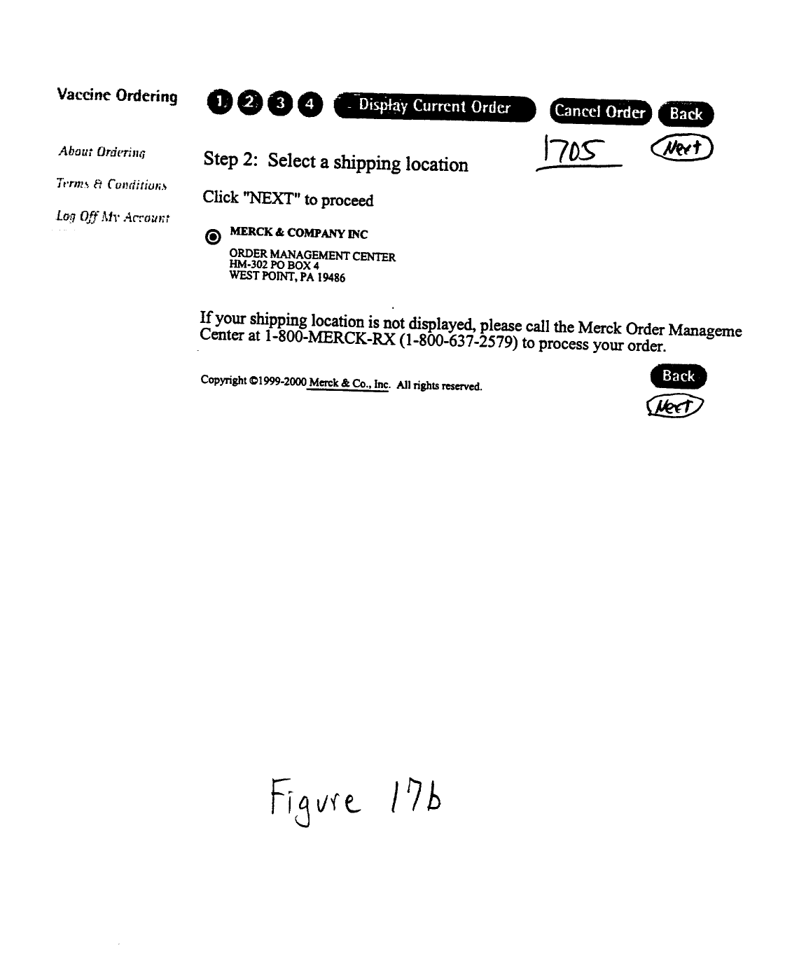

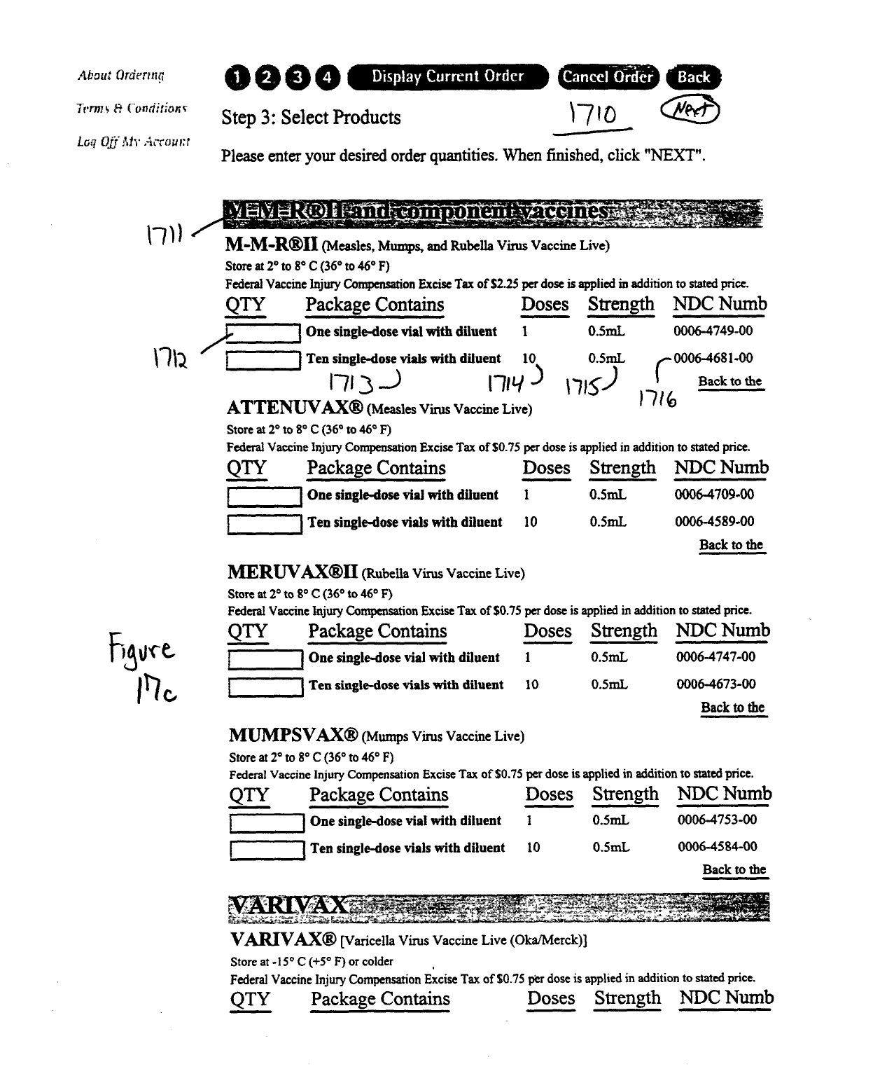

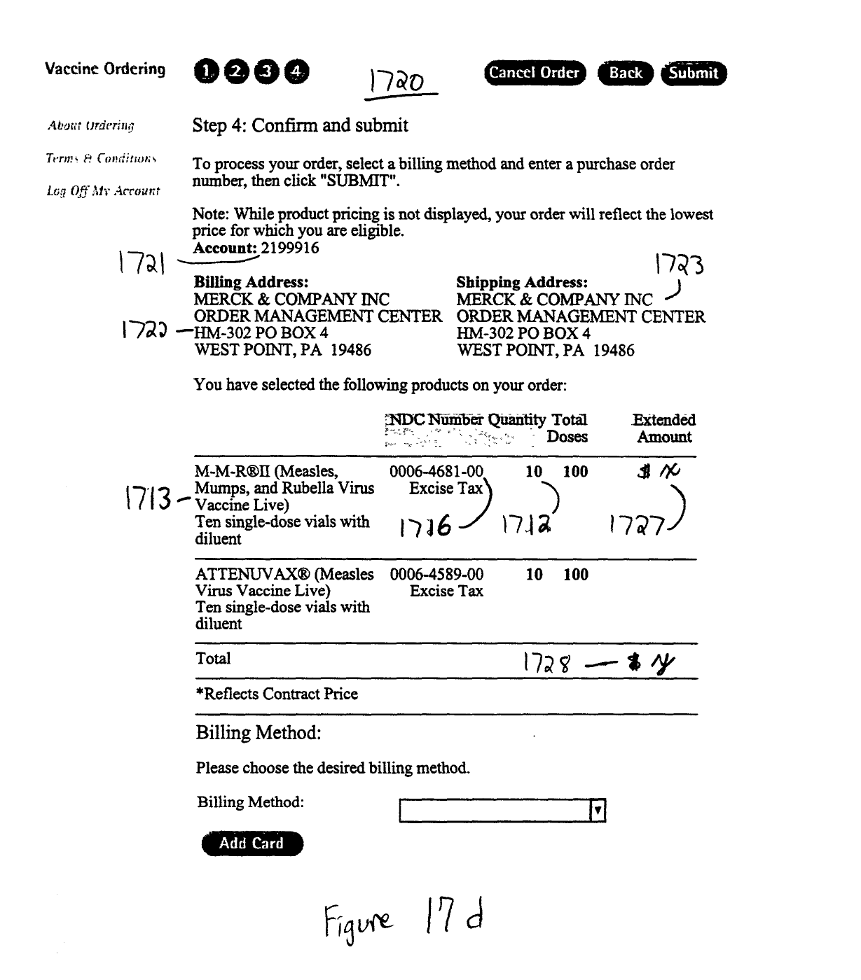

FIG. 17a, illustrates a web page 1700 for receiving purchaser information, in accordance with step 1500 of FIG. 15. As shown in FIG. 17a, account number 2199916, which corresponds to an account listing Merck & Company, Inc. as the custom, is received at step 1500b.

Selecting “Next” on web page 1700 displays web page 1705, as shown in FIG. 17b, which also corresponds with step 1500 of FIG. 15. At step 1500c, order processing application 200 receives a shipping location. For example, as shown in FIG. 17b, order processing application 200 receives a shipping location of West Point, Pa. 19486.

In one embodiment, at step 1500d, order processing application 200 may also receive a purchase identification number, for example a purchase order number or the like. The purchase identification number may be stored by the order processing application in order database 220d, for later use by the purchaser. Further, order processing application 200 may require the purchaser to submit a purchase identification number prior to processing the order.

Selecting “Next” on web page 1705 displays web page 1710, as shown in FIG. 17c, which corresponds with steps 1505 and 1510 of FIG. 15. At step 1505, order processing application 200 displays a vaccine description. For example, order processing application 200 causes web page 1710 to be displayed. Web page 1710 includes a vaccine name 1711, a quantity field 1712, a package description 1713, a dose description 1714, a strength description 1715, and a National Drug Code (NDC) number 1716.

At step 1510, order processing application 200 receives a selection of a vaccine. For example, a purchaser may enter a number in the quantity field 1712 for transmittal of the entered quantity to order processing application 200.

Selecting “Next” on web page 1710 displays web page 1720, as shown in FIG. 17d, which corresponds with step 1520 of FIG. 15. Order processing application 200 displays a summary of the vaccine product order for confirmation of the order. As shown in FIG. 17d, web page 1720 includes an account number 1721, a billing address 1722, a shipping address 1723, the description 1713 of each vaccine product ordered, the NDC number 1716 corresponding to each vaccine product ordered, the quantity 1712 of each vaccine product ordered, a price 1727 for each vaccine product ordered, and a total price 1728 of the order.

At step 1525, the purchaser may confirm the order by selecting “Submit” or reject the order by selecting “Cancel Order.” If order processing application 200 receives a confirmation of the order (i.e., the purchaser selected “Submit”), then the method proceeds to step 1530. If order processing application 200 does not receive a confirmation, the method may end, proceed back to step 1500, or proceed to step 1510.

At step 1530, order processing application 200 processes the vaccine product order. Order processing application 200 may process the order by processing the purchaser information and the order information and forwarding the order information to an order fulfillment system and to a billing system. Alternatively, order processing application 200 may perform the fulfillment and/or billing functions.

In one embodiment, order processing application 200 processes the order with a credit card number. In another embodiment, order processing application 200 processes the order with extended credit terms. In this manner, a purchaser may manage cash flow, which in a physician office may be the second highest expense item. That is, credit card usage and extended payment terms may alleviate some of the strain of out-of-pocket vaccine purchase expenses that are awaiting reimbursement.

At step 1535, order processing application 200 sends order confirmation information. For example, a first confirmation including a confirmation number may be sent to the purchaser. Thereafter, a second confirmation in the form of an email message may also be sent to the purchaser. In this manner, the purchaser may review the order on client computer 154, may confirm or reject the order, and may receive and review a confirmation after accepting the order, thereby decreasing the chance of an ordering mistake.

At step 1540, order processing application 200 creates an invoice based on the received purchaser information and product order information and charges the invoice to the purchaser's selected account.

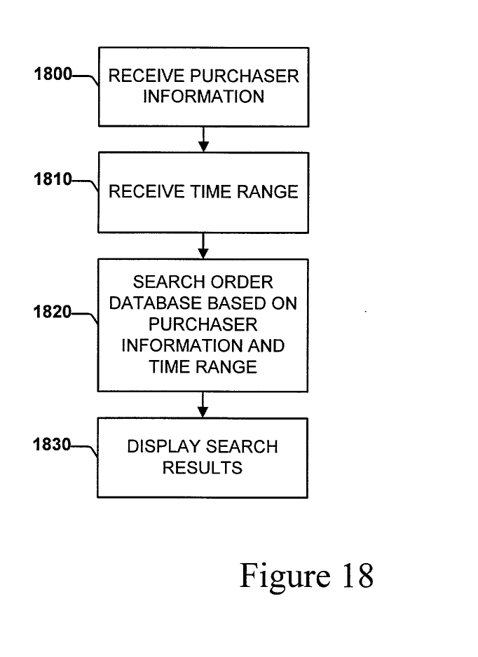

Referring back to FIG. 16, upon receiving a selection of “Order History”, order processing application 200 begins performing the method of FIG. 18. As shown in FIG. 18, at step 1800, order processing application 200 receives purchaser information, similar to that described above in connection with step 1400 of FIG. 15.

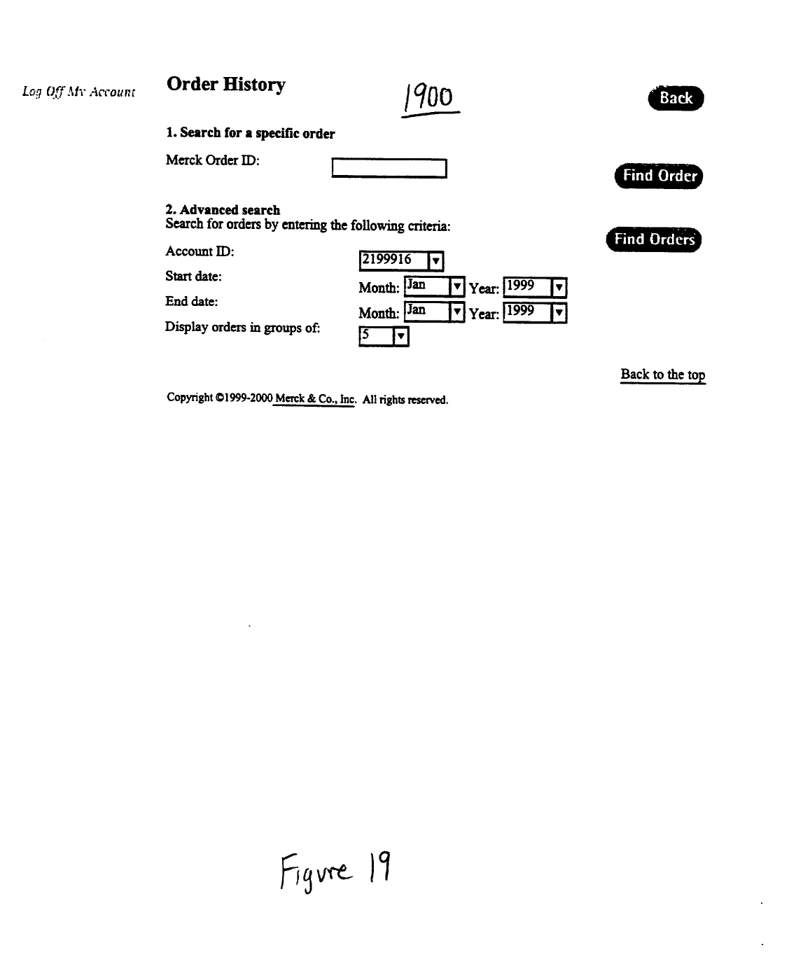

FIG. 19 illustrates a web page 1900 for receiving purchaser information, in accordance with step 1800 of FIG. 18. As shown in FIG. 19, account number 2199916, which corresponds to an account of Merck & Company, Inc., is received by order processing application 200.

At step 1810, order processing application 200 receives a time range for retrieving vaccine product order information. For example, as shown in FIG. 19, order processing application 200 receives a start date of January 1999 and an end date of January 1999.

At step 1820, order processing application 200 searches for orders corresponding to the purchaser information and within the time range received. For example, upon selection of “Find Orders” on FIG. 19, order processing application 200 searches order database 220d for all orders for account 2199916 in January of 1999.

At step 1830, order processing application 200 displays the results of the search, perhaps with pages of results for large sets of vaccine product orders. In this manner, a purchaser may retrieve and review historical orders of vaccine products.

Alternatively, in place of steps 1800 through 1810, order processing application 200 may receive a purchase order number. In this case, at step 1820, order processing application 200 searches order database 220d for the received purchase order number.

Order processing application 200 may also support updating of account information, ordering of literature, referring a colleague, ordering ancillary items such as posters and consumer literature, and the like. Moreover, in one embodiment of the invention, the purchaser can submit requests for vaccine-related professional information (i.e., a Professional information Request (PIR)), and can receive a copy of a response by way of a web page and/or an email message, in addition to a regular mail response.

As can be seen, the invention provides a computerized system and method for ordering vaccine products and for providing information and support services relevant to such vaccine products via a communications network.

As such, the invention can help purchasers manage their time by providing them ready access to healthcare news and information in a convenient, reliable fashion, their costs by enabling them to view their vaccine-ordering history so they can better predict their future needs and manage their inventory accordingly, and their cash flow by providing support services. The invention also allows a purchaser to directly perform all phases of vaccine ordering and information retrieval, including selecting account and billing information, selecting vaccines, receiving confirmations, checking on orders, obtaining related vaccine information, and the like, at any time of the day or night, and without the need for interacting with a clerk or the like at the vaccine supplier.

Viewing the invention more broadly, given the existing vaccine market, the invention supplements product-differentiation efforts with service offerings that engender purchaser loyalty.

The wide accessibility of disease, product, and business-transaction information, as well as the cross-media coordination of promotional efforts, allows a vaccine supplier not only to effectively and efficiently market their products and services, but also to communicate their messages broadly to audiences whom they might otherwise be unable to reach. For example, either directly to primary care physicians, or through intermediaries such as HMOs, PBMs, or others, the Internet provides vaccine manufacturers with the flexibility to communicate messages about pediatric and adult vaccines. At the same time, the empowerment of consumers creates a platform to launch consumer-driven adult and adolescent vaccines.

The invention may be embodied in the form of program code (i.e., instructions) stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer, the machine becomes an apparatus for practicing the invention. The invention may also be embodied in the form of program code that is transmitted over some transmission medium, such as over electrical wiring or cabling, through fiber optics, over a network, including the Internet or an intranet, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

It is noted that the foregoing illustrations have been provided merely for the purpose of explanation and are in no way to be construed as limiting of the invention. While the invention has been described with reference to illustrative embodiments, it is understood that the words which have been used herein are words of description rather than words of limitation. Further, although the invention has been described herein with reference to particular structure, methods, and embodiments, the invention is not intended to be limited to the particulars disclosed herein; rather, the invention extends to all structures, methods and uses that are within the scope of the appended claims. Those skilled in the art, having the benefit of the teachings of this specification, may effect numerous modifications thereto and changes may be made without departing from the scope and spirit of the invention, as defined by the appended claims.

What is claimed is:

1. A method for processing a vaccine product order via a computer communications network, the method comprising:
receiving an indication of a purchaser via the communications network;
receiving an indication of the vaccine product and an indication of a quantity to be ordered via the communications network; and
processing the order based on the purchaser, the vaccine product, and the quantity.

2. The method as recited in claim 1, further comprising:
sending a prompt for a password via the communications network;
receiving a password via the communications network; and
comparing the received password to a predefined password, and processing the order for a vaccine product only if the received password is identical to the predefined password.

3. The method as recited in claim 1, wherein receiving an indication of a purchaser comprises receiving one of a purchaser name, a purchaser identification, a selection of a purchaser name, and a selection of a purchaser identification.

4. The method as recited in claim 1, further comprising receiving an indication of a shipping address via the communications network.

5. The method as recited in claim 1, further comprising determining a shipping address corresponding to the purchaser.

6. The method as recited in claim 1, further comprising receiving an indication of an account via the communications network.

7. The method as recited in claim 1, further comprising determining an account corresponding to the purchaser.

8. The method as recited in claim 1, further comprising:
sending a list of vaccine products available for ordering via the communications network, prior to receiving an indication of a vaccine product, wherein a purchaser can select from the list the vaccine product and a quantity thereof.

9. The method as recited in claim 8, wherein the list of vaccine products further comprises a price for each listed vaccine product.

10. The method as recited in claim 1, wherein receiving an indication of a vaccine product comprises receiving one of a vaccine product name, a vaccine product identification, a selection of a vaccine product name, and a selection of a vaccine product identification.

11. The method as recited in claim 1, wherein processing the order comprises:
determining a price based upon the purchaser, the vaccine product, and the quantity;
sending an indication of the vaccine product, the quantity, and the determined price via the communications network for confirmation of the order; and
receiving a confirmation of the order via the communications network.

12. The method as recited in claim 11, wherein determining a price comprises determining a lowest total price based on the purchaser.

13. The method as recited in claim 11, wherein determining a price comprises determining a price based on at least one of an account corresponding to the purchaser and a shipping address corresponding to the purchaser.

14. The method as recited in claim 1, further comprising creating an invoice based on the purchaser, the vaccine product, the quantity, and the price.

15. The method as recited in claim 1, further comprising:
sending a confirmation of the order via the communications network.

16. The method as recited in claim 15, wherein the confirmation is one of a web page and an e-mail.

17. The method as recited in claim 1, wherein processing the order comprises processing the order with a credit card number.

18. The method as recited in claim 1, wherein processing the order comprises processing the order with extended credit terms.

19. The method as recited in claim 1, further comprising:
sending a list of information corresponding to the vaccine product via the communications network;
receiving a selection of information via the communications network; and
sending the selected information via the communications network.

20. A method for retrieving vaccine product order information via a computer communications network, the method comprising:
receiving a search criterion for a vaccine product order via a communications network;
searching a data store for a vaccine product order based on the search criterion; and
sending, based on the search, at least one vaccine product order meeting the search criterion via the communications network.

21. The method as recited in claim 20 wherein receiving a search criterion comprises receiving a purchase order number.

22. The method as recited in claim 20 wherein receiving a search criterion comprises:
receiving one of an indication of a purchaser and an indication of an account via the communications network; and
receiving an indication of a date range via the communications network.

23. A method for providing vaccine product information via a computer communications network, the method comprising:
receiving an indication of a vaccine product via the communications network;
sending a list of information corresponding to the vaccine product via the communications network;
receiving a selection from the list of information via the communications network; and
sending information corresponding to the selection via the communications network.

24. The method as recited in claim 23, wherein sending a list of information comprises sending a list of information comprising one of product information, prescribing information, support information, a hyper text transport protocol link to other information, an article, and storage and handling information.

25. The method as recited in claim 23, wherein sending information comprises sending one of product information, prescribing information, support information, a hyper text transport protocol link to other information, an article, and storage and handling information.

26. A method for providing purchaser relevant vaccine product information via a computer communications network, the method comprising:
receiving an indication of a purchaser via the communications network;
determining an area of interest corresponding to the purchaser; and
sending vaccine product information via the communication network based on the determined area of interest.

27. The method as recited in claim 26 wherein determining an area of interest comprises determining an area of interest from one of a database and the Internet.

28. The method as recited in claim 26, wherein sending vaccine product information comprises sending one of product information, prescribing information, support information, a hyper text transport protocol link to other information, an article, and storage and handling information.

29. A method for selling vaccine product via a computer communications network, the method comprising:
providing vaccine product pricing information via the communications network;
providing vaccine product support information via the communications network;
receiving vaccine product order information via the communications network; and
processing a vaccine product order based on the order information.

30. A computer-readable medium having computer readable instructions thereon for processing a vaccine product order via a computer communications network, the instructions when executed on a processor, causing the processor to perform the following:
receiving an indication of a purchaser via the communications network;
receiving an indication of the vaccine product and an indication of a quantity to be ordered via the communications network; and
processing the order based on the purchaser, the vaccine product, and the quantity.

31. The computer-readable medium as recited in claim 30, wherein the instructions further cause the processor to perform determining one of a shipping address and an account corresponding to the purchaser.

32. The computer-readable medium as recited in claim 30 wherein the instructions further cause the processor to perform:
sending a list of vaccine products available for ordering via the communications network, prior to receiving an indication of a vaccine product, wherein a purchaser can select from the list the vaccine product and a quantity thereof.

33. The computer-readable medium as recited in claim 30, wherein processing the order comprises:
determining a price based upon the purchaser, the vaccine product, and the quantity;
sending an indication of the vaccine product, the quantity, and the determined price via the communications network for confirmation of the order; and
receiving a confirmation of the order via the communications network.

34. The computer-readable medium as recited in claim 33, wherein determining a price comprises determining a price based on at least one of an account corresponding to the purchaser and a shipping address corresponding to the purchaser.

35. The computer-readable medium as recited in claim 30, wherein the instructions further cause the processor to perform creating an invoice based on the purchaser, the vaccine product, the quantity, and the price.

36. The computer-readable medium as recited in claim 30, wherein the instructions further cause the processor to perform sending a confirmation of the order via the communications network.

37. The computer-readable medium as recited in claim 30, wherein processing the order comprises processing the order with one of a credit card number and extended credit terms.

38. A computer-readable medium having computer-readable instructions thereon for providing purchaser relevant vaccine product information via a computer communications network, the instructions when executed on a processor performing the following:
receiving an indication of a purchaser via the communications network;
determining an area of interest corresponding to the purchaser; and
sending vaccine product information via the communication network based on the determined area of interest.

39. The computer-readable medium as recited in claim 38 wherein determining an area of interest comprises determining an area of interest from one of a database and the Internet.

40. The computer-readable medium as recited in claim 38, wherein sending vaccine product information comprises sending one of product information, prescribing information, support information, a hyper text transport protocol link to other information, an article, and storage and handling information.

41. A computer-readable medium having computer-readable instructions thereon for selling vaccine product via a computer communications network, the instructions when executed on a processor performing the following:
providing vaccine product pricing information via the communications network;
providing vaccine product support information via the communications network;
receiving vaccine product order information via the communications network; and
processing a vaccine product order based on the order information.

42. A system for processing a vaccine product order via a computer communications network, the system comprising:
a data store containing account information, purchaser information, and product information; and
an order processing application that performs:
receiving an indication of a purchaser via the communications network;
receiving an indication of the vaccine product and an indication of a quantity to be ordered via the communications network; and
processing the order based on the purchaser, the vaccine product, and the quantity.

43. The system as recited in claim 42, wherein the order processing application further performs determining a shipping address corresponding to the purchaser.

44. The system as recited in claim 42, wherein the order processing application further performs determining an account corresponding to the purchaser.

45. The system as recited in claim 42, wherein the order processing application further performs sending a list of vaccine products available for ordering via the communications network, prior to receiving an indication of a vaccine product, wherein a purchaser can select from the list the vaccine product and a quantity thereof.

46. The system as recited in claim 45, wherein the list of vaccine products further comprises a price for each listed vaccine product.

47. The system as recited in claim 42, wherein processing the order comprises:
determining a price based upon the purchaser, the vaccine product, and the quantity;
sending an indication of the vaccine product, the quantity, and the determined price via the communications network for confirmation of the order; and
receiving a confirmation of the order via the communications network.

48. The system as recited in claim 47, wherein determining a price comprises determining a price based on at least one of an account corresponding to the purchaser and a shipping address corresponding to the purchaser.

49. The system as recited in claim 42, wherein the order processing application further performs creating an invoice based on the purchaser, the vaccine product, the quantity, and the price.

50. The system as recited in claim 42, wherein the order processing application further performs sending a confirmation of the order via the communications network in the form of one of a web page and an e-mail.

51. The system as recited in claim 42, wherein processing the order comprises processing the order with one of a credit card number and extended credit terms.

52. A system for retrieving vaccine product order information via a computer communications network, the system comprising:
a data store containing product information; and
an order processing application that performs:
receiving a search criterion for a vaccine product order via a communications network;
searching a data store for a vaccine product order based on the search criterion; and
sending, based on the search, at least one vaccine product order meeting the search criterion via the communications network.

53. A system for providing purchaser relevant vaccine product information via a computer communications network, the system comprising:
an order processing application that performs:
receiving an indication of a purchaser via the communications network;
determining an area of interest corresponding to the purchaser; and
sending vaccine product information via the communication network based on the determined area of interest.

54. The system as recited in claim 53 wherein determining an area of interest comprises determining an area of interest from one of a database and the Internet.
